(19) United States
(12) Patent Application Publication
(10) Pub. No.: US 2021/0162518 A1
(43) Pub. Date: Jun. 3, 2021

(54) Dimpled Workpiece and Dimple Processing Method

(71) Applicant: KANEFUSA KABUSHIKI KAISHA, Niwa-gun, Aichi (JP)

(72) Inventors: Satoru NISHIO, Niwa-gun, Aichi-ken (JP); Tatsuya NIIMI, Niwa-gun, Aichi-ken (JP); Toshiki SATO, Niwa-gun, Aichi-ken (JP); Yasuyuki KANDA, Niwa-gun, Aichi-ken (JP)

(73) Assignee: KANEFUSA KABUSHIKI KAISHA, Niwa-gun, Aichi (JP)

(21) Appl. No.: 17/048,307

(22) PCT Filed: Mar. 22, 2019
(86) PCT No.: PCT/JP2019/012111

§ 371 Date: Oct. 16, 2020

(30) Foreign Application Priority Data
Apr. 18, 2018 (JP) 2018-079807

(51) Int. Cl. B23C 3/13; B23C 5/12; F16C 33/10

(52) U.S. Cl. CPC B23C 3/13; F16C 33/10; B23C 5/12

(57) ABSTRACT

A plurality of dimples are formed on a processing surface of a workpiece. An aspect ratio of each dimple is greater than or equal to 5.0 and less than or equal to 50.0. The aspect ratio is a ratio of a length of the dimple measured in a longitudinal direction to a lateral width of the dimple measured in a direction perpendicular to the longitudinal direction.

### CROSS-REFERENCE TO RELATED APPLICATIONS

The present application is a 35 U.S.C. § 371 national stage application, and claims priority to, PCT Application No. PCT/JP2019/012111, filed Mar. 22, 2019, which claims priority to Japanese Patent Application No. 2018-079807, filed Apr. 18, 2018, both of which are hereby incorporated herein by reference in their entireties for all purposes.

### STATEMENT REGARDING FEDERALLY SPONSORED RESEARCH OR DEVELOPMENT

Not applicable.

### BACKGROUND

The present disclosure relates generally workpieces including a surface having a plurality of dimples and methods for forming pluralities of dimples on the surfaces of workpieces.

Dimples, in the form of a plurality of fine recesses, may be formed on a surface of a workpiece, such as aluminum, a copper alloy, a cast product thereof, a steel material, or resin, by so-called scraping. A satin pattern, for example, may be formed using the plurality of the dimples on the surface of the workpiece. Frictional resistance between the workpiece and a counterpart material coming in contact with the workpiece can be reduced by dimples on the workpiece. The principle is that, for example, wear debris generated as the workpiece comes in contact with the counterpart material can be captured between the workpiece and the counterpart material, thereby increasing the frictional resistance. However, such an increase in frictional resistance due to wear debris may be reduced and/or prevented by allowing the wear debris to be captured in the dimples. Alternatively, an oil may be injected between the workpiece and the counterpart material, such that the oil may fill the dimples. When the counterpart material passes near the dimples, the oil may be squeezed out from the dimples and into the space between the counterpart material and the workpiece (squeeze effect) at high pressure, thereby reducing direct contact between the counterpart material and the workpiece. Consequently, the frictional resistance between the counterpart material and the workpiece may be reduced.

### BRIEF SUMMARY

One aspect of the present disclosure relates to a dimpled workpiece provided with a plurality of dimples configured to increase the pressure of an oil film between the workpiece and a counterpart material. Each of the plurality of dimples has an aspect ratio of greater than or equal to 5.0 and less than or equal to 50.0, the aspect ratio being a ratio of the length in the longitudinal direction to the lateral width in the lateral direction perpendicular to the longitudinal direction.

According to the foregoing aspect, the dimples have an elongated shape in the longitudinal direction. The dimples may have, for example, a spindle shape, an elliptical shape, a rectangular shape, or a rhombus shape. In the elongated dimples having an aspect ratio of 5.0 or more, the generation of vortex-like turbulence of the oil flow may be suppressed. Further, the oil flow in the dimples will have a less turbulent flow along the longitudinal direction of the dimples. Therefore, it is possible to suppress a reduction in pressure of the oil film due to the turbulence of the oil flow in the dimples. The pressure of the oil film can thus be efficiently increased by the dimples.

According to another aspect of the present disclosure, the plurality of the dimples may include a plurality of first dimples parallel to each other, and a plurality of second dimples parallel to each other. The plurality of the first dimples and the plurality of the second dimples may be arranged so that the longitudinal direction of the plurality of the first dimples and the longitudinal direction of the plurality of the second dimples intersect at angles.

According to this aspect, the oil may more easily flow around the first dimples along the longitudinal direction of the first dimples. In addition, the oil may more easily flow around the second dimples along the longitudinal direction of the second dimples. The longitudinal direction of the first dimples and the longitudinal direction of the second dimples intersect at angles. Therefore, the oil flow around the first dimples and the oil flow around the second dimples may converge. Due to the convergence of oil flow, the oil captured between the workpiece and the counterpart material will less likely flow out from between these components, and the oil can therefore be maintained therebetween.

According to another aspect of the present disclosure, the depth of each of the plurality of dimples may be 10.0 μm or less. End edges of each of the dimples in the longitudinal direction may have an inclination angle of 10° or less in the depth direction with respect to the surface of the workpiece. The plurality of dimples may thus be formed with a shallow bottom and, particularly, the end edges in the longitudinal direction may be formed to be smoothly continuous with the surface of the workpiece. Therefore, a vortex may also be suppressed and/or prevented from being generated due to the oil flow in the dimples in the depth direction of the dimples. In addition, turbulence of the oil flow along the longitudinal direction of the dimples may be reduced. Consequently, a reduction in pressure of the oil film due to turbulence of the oil flow in the dimples may be suppressed. As a result, the pressure of the oil film can be efficiently increased by the dimples.

Another aspect of the present disclosure relates to a method for forming dimples in a surface of a workpiece using a rotary cutting tool. The rotary cutting tool comprises a tool main body supported rotatably about an axis and a cutting edge provided on the outer circumference of the tool main body so as to project in a direction intersecting with the direction in which the axis extends. The rotary cutting tool may be rotated about the axis and fed along a processing surface of the workpiece while rotating, so as to form dimples on the processing surface using the cutting edge. Each dimple has an aspect ratio greater than or equal to 5.0 and less than or equal to 50.0, the aspect ratio being a ratio of the length in the longitudinal direction to the lateral width in the lateral direction perpendicular to the longitudinal direction.

The plurality of the dimples having a relatively large aspect ratio of 5.0 or more can be easily formed on the surface of the workpiece. For example, it is possible to form a plurality of dimples arranged in parallel in the direction in which the workpiece moves relative to the counterpart material with relative ease. Alternatively, it is possible to form a plurality of dimples in which the plurality of dimples are arranged at equal intervals in another direction intersecting with the direction in which the workpiece moves relative to the counterpart material.

### BRIEF DESCRIPTION OF THE DRAWINGS

FIG. 1 is an enlarged partial cross-sectional side view of an embodiment of a rotary cutting tool in accordance with the principles described herein for forming spindle shaped dimples along a surface of a workpiece.

FIG. 2 is an enlarged front view of the workpiece of FIG. 1 illustrating the spindle shaped dimples.

FIG. 3 is a cross-sectional view of the workpiece of FIG. 2 taken along line in FIG. 2.

FIG. 4 is an enlarged partial cross-sectional side view of an embodiment of a rotary cutting tool in accordance with the principles described herein for forming ellipse shaped dimples in a surface of a workpiece.

FIG. 5 is an enlarged front view of the workpiece of FIG. 4 illustrating the ellipse shaped dimples.

FIG. 6 is a cross-sectional view of the workpiece of FIG. 5 taken along line VI-VI in FIG. 5.

FIG. 7 is a partial cross-sectional front view of a crank shaft and an embodiment of a rotary cutting tool in accordance with the principles described herein for forming dimples in a crankpin of the crank shaft.

FIG. 8 is a partial cross-sectional plan view of the crankpin of the crank shaft and the rotary cutting tool of FIG. 7.

FIG. 9 is an enlarged front view of the crankpin of FIG. 8 illustrating the dimples.

FIG. 10 is a cross-sectional view of the crankpin of FIG. 9 taken along line X-X in FIG. 9.

FIG. 11 is an enlarged front view of a workpiece having a surface formed with a plurality of first dimples and a plurality of second dimples oriented at intersecting angles relative to each other.

FIG. 12 is an enlarged side view of the rotatory cutting tool of FIG. 7 illustrating the portion XII in FIG. 7.

FIG. 13 is an enlarged side view of an embodiment of rotary cutting tool in accordance with the principles described herein and having a cutting edge for forming spindle shaped dimples.

FIG. 14 is a perspective view of an embodiment of the rotary cutting tool in accordance with the principles described herein for simultaneously forming dimples in a plurality of rows and the workpiece.

FIG. 15 is a cross-sectional view of a part of a cylindrical workpiece and an embodiment of rotary cutting tool in accordance with the principles described herein for forming dimples on the inner circumferential surface of the workpiece.

FIG. 16 is a partial cross-sectional side view of the cylindrical workpiece and the rotary cutting tool of FIG. 15.

FIG. 17 is an enlarged front view of the workpiece of FIG. 15 formed with the spindle shaped dimples.

FIG. 18 is a front view of an embodiment of a bit for forming dimples and a workpiece.

FIG. 19 is a graph illustrating the relationship between the load and the frictional coefficient for different dimple shapes.

FIG. 20 is a graph illustrating the relationship between the aspect ratio of the dimples and the frictional coefficient.

FIG. 21 is a graph illustrating the relationship between the speed/load and the frictional coefficient.

FIG. 22 is an enlarged front view of a workpiece having circular dimples along its surface formed in accordance with methods described herein.

FIG. 23 is an enlarged front view of a workpiece having spindle shaped dimples along its surface formed in accordance with methods described herein.

FIG. 24 is an enlarged front view of a workpiece having a plurality of first dimples and a plurality of second dimples along its surface with their longitudinal directions intersecting at angles and formed in accordance with methods described herein.

FIG. 25 is a graph illustrating the relationship between the load and the frictional coefficient for different shapes and sizes of dimples.

### DETAILED DESCRIPTION

As previously described, dimples in the form of recesses on the surface of a workpiece may reduce frictional resistance between the workpiece and a counterpart material. For example, dimples may be formed on an inner wall of a tubular member, such as a cylinder for an engine, a turbocharger, etc. or joint surfaces of artificial joints to reduce frictional resistance. Japanese Laid-Open Patent Publication No. H10-052998 discloses a method for forming dimples on a surface of a workpiece using a rotary cutting tool, such as a milling cutter or an end milling cutter. According to the method, a cutting edge of a rotary cutting tool may be slightly abutted against the surface of the workpiece while the rotary cutting tool rotates. In this way, a plurality dimples having, for example, a circular shape or an elliptical shape can be formed in a polka dot pattern on the surface of the workpiece. The dimples are thus formed, for example, in parallel with an axial direction of the rotary cutting tool and at equal intervals in a feed direction orthogonal to the axial direction.

When oil is provided between the workpiece and the counterpart material, and the workpiece and the counterpart material move relative to each other, oil pressure and shear force are generated therebetween, thereby inducing oil flow. The oil flow may cause vortex-like turbulence (for example, cavitation) in the dimples, when the dimples are circular. The vortex-like turbulence of the oil flow may contribute a reduction in the pressure of the oil film. It is generally desirable to suppress turbulence of the oil flow in the dimples to minimize and/or avoid a reduction in the pressure of the oil film. Therefore, there has been a need for a workpiece with a plurality of dimples configured to reduce and/or prevent the turbulence of the oil flow in the dimples. There has also been a need for a processing method for forming such dimples in a workpiece.

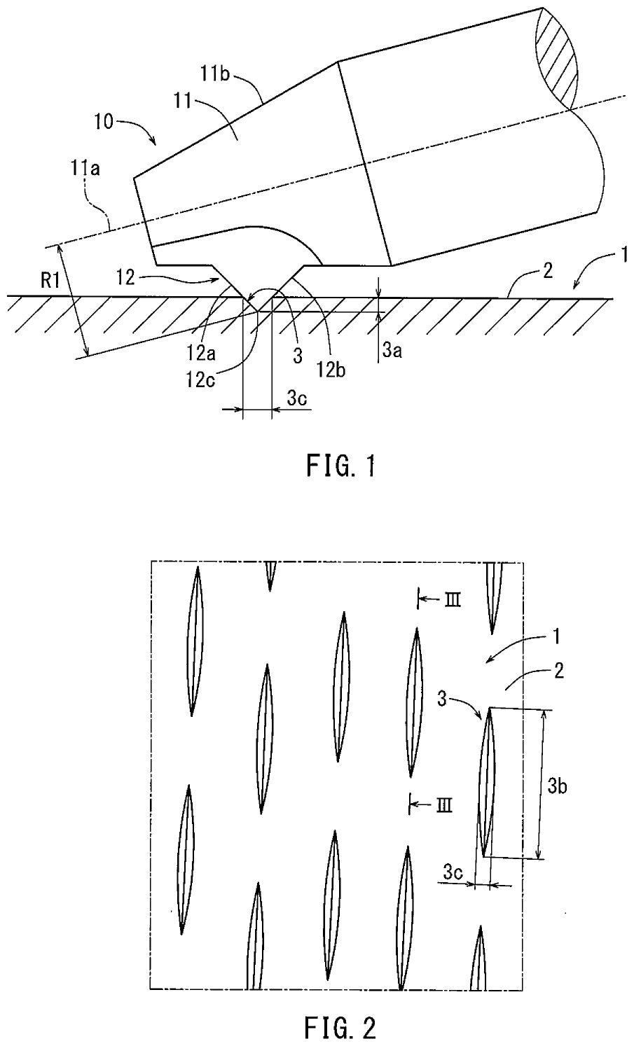

Hereinafter, an embodiment of the present disclosure will be described with reference to FIGS. 1 to 3. As shown in FIG. 1, a metal workpiece 1 has an outer, processing surface 2 configured to come in contact with a counterpart material. A plurality of spaced dimples 3 are formed along and in the processing surface 2 using a rotary cutting tool 10. The workpiece 1 may be made of a steel material such as, for example, carbon steel, rolled steel for general structure, chrome molybdenum steel, stainless steel, cast iron, etc. Alternatively, the workpiece 1 may be made of, for example, a non-ferrous metal, such as, for example, aluminum, aluminum alloys, copper, or copper alloys, or a resin material. The rotary cutting tool 10 includes a tool main body 11 having a central axis 11a and a cutting edge 12 projecting radially outward from a portion of the radially outer surface 11b of the tool main body 11. The tool main body 11 may have a columnar shape, a conical shape, or other rotatable body shape disposed about the axis 11a. The tool main body 11 may have one or a plurality of cutting edge(s) 12. If a plurality of cutting edges 12 are provided, they may be arranged on the radially outer surface 11b of the tool main body 11 at intervals in a circumferential direction and/or in an axial direction, for example, at equidistant positions on the radially outer surface 11b in the circumferential direction and/or the axial direction.

As shown in FIG. 1, the cutting edge 12 has a first bottom edge 12a and a second bottom edge 12b. The first bottom edge 12a may have a planar surface that is inclined by a predetermined angle with respect to the radial direction and the axial direction of the tool main body 11. The second bottom edge 12b may have a planar surface that is inclined by a predetermined angle with respect to the radial direction and the axial direction of the tool main body 11, and that intersects with the first bottom edge 12a at an angle. The first bottom edge 12a and the second bottom edge 12b intersect to form a V-shaped leading tip or end 12c. Thus, in this embodiment, the cutting edge 12 has a triangular shaped rake face. The rake face of the cutting edge 12 generally extends in the circumferential direction of the tool main body 11.

The cutting edge 12 may be made of the same material as the tool main body 11 of the rotary cutting tool 10 or of a different material. The cutting edge 12 and the tool maim body 11 may both be made of, for example, tool steel, high speed steel (high speed tool steel), or cemented carbide. Alternatively, the tool main body 11 may be made of, for example, carbon steel, stainless steel, tool steel, high speed steel, or cemented carbide, while the cutting edge 12 is formed, for example, of polycrystalline diamond (PCD), cubic boron nitride (CBN), or ceramics. The cutting edge 12 may be a separate piece that is fixably joined to the tool main body 11. Alternatively, the cutting edge 12 may be formed of the same or different material as that of the tool main body 11, and a corresponding area of the cutting edge 12 may be subjected to surface treatment, such as coating, etc. The surface treatment is performed, for example, by chemical vapor deposition (CVD) or physical vapor deposition (PVD). Ti-based coating layer, such as TiAlN, TiAlCrN, TiAlCrSiN coating layer, or other coating layers such as CVD diamond or diamond-like carbon (DLC), may be used as the cutting edge 12.

Referring to FIGS. 1 and 2, the process of forming dimples 3 by scraping with the rotary cutting tool 10 is illustrated. The rotary cutting tool 10 is rotatably supported and configured to rotate about the axis 11a in a posture in which the radial direction of the tool main body 11 intersects the processing surface 2. The distance of the rotary cutting tool 10 from the processing surface 2 is set based on the maximum desired depth 3a of the dimple 3. In this embodiment, the rotary cutting tool 10 is positioned at a distance from the processing surface 2 such that the maximum depth 3a ranges from 3 to 7 μm, e.g., 5 μm. The rotary cutting tool 10 is rotated about the axis 11a and shifted relative to the processing surface 2 in the cutting direction of the cutting edge 12. In this way, a plurality of the dimples 3 are formed in series in a longitudinal direction and are spaced apart from each other.

As shown in FIGS. 2 and 3, the dimples 3 formed on the processing surface 2 may have a so-called spindle shape. As previously described, the maximum depth 3a of each dimple 3 may be 3 to 7 μm, e.g., 5 μm. The length 3b of each dimple 3 measured in the longitudinal direction (e.g., along the longitudinal direction of the dimple 3) may range from 0.10 to 1.00 mm, for example, 0.20 mm. The lateral width 3c of each dimple 3 measured perpendicular to the longitudinal direction of the dimple 3 may be, for example, 0.010 mm. The lateral width 3c may be selected so that the aspect ratio (the ratio of the length 3b to the lateral width 3c) is greater than or equal to 5.0 and less than or equal to 50.0. The longitudinal ends of each dimple 3 slope downward from the adjacent portions of processing surface 2 at an inclination angle of 10.0° or less measured downward in the depth direction with respect to the processing surface 2. The longitudinal ends of each dimple 3 have a triangular shape defined by the corresponding edges angularly spaced apart at an angle of 60.0° or less in the plan view. The plurality of dimples 3 may be spaced apart at predetermined intervals, for example, 0.30 mm, in the longitudinal direction. In some embodiments, the spacing interval in the longitudinal direction is longer than, for example, the length 3b.

As shown in FIG. 2, the plurality of dimples 3 may be formed in the workpiece 1 to increase the pressure of an oil film positioned between the processing surface 2 and a counterpart material. The aspect ratio of each dimple 3 is greater than or equal to 5.0 and less than or equal to 50.0, where the aspect ratio is the ratio of the length 3b in the longitudinal direction to the lateral width 3c in the direction perpendicular to the longitudinal direction. In this embodiment, each dimple 3 has a spindle shape that is elongated in the longitudinal direction.

The dimples 3 are sized and shaped to suppress the generation of vortex-like turbulence within the oil flow between the processing surface and a counterpart material. Further, the oil flow in the dimples 3 will be less turbulent along the longitudinal direction of the dimple 3. Accordingly, a reduction in the oil film pressure due to turbulence of the oil flow in the dimples 3 may be suppressed. Further, the plurality of dimples 3 are formed on the processing surface 2 so that their longitudinal directions are parallel to each other and are spaced apart from each other. The oil flow in the dimples 3 primarily corresponds to the longitudinal direction of the dimples 3. Therefore, particularly when the moving direction of the workpiece 1 relative to the counterpart material is along the longitudinal direction of the dimples 3, the oil film pressure between the workpiece 1 and the counterpart material is effectively increased. The dimples 3 thus allow the pressure of the oil film between the workpiece 1 and the counterpart material to effectively increase.

As shown in FIGS. 1 and 3, each dimple 3 has a maximum depth 3a measured perpendicularly from the processing surface 2 of 10 μm or less. In addition, as previously described, the longitudinal ends of each dimple 3 slope downward from the processing surface 2 at an inclination angle θ of 10.0° or less. Therefore, each dimple 3 has a relatively shallow bottom, and in particular, the longitudinal ends of each dimple 3 smoothly and continuously transition to/from the processing surface 2. Therefore, also in the depth direction of each dimple 3, generation of a vortex-like turbulence due to the oil flow in the dimple 3 is suppressed. Moreover, the oil flow is less disturbed along the longitudinal direction of the dimple 3. Therefore, a reduction in the oil film pressure due to the turbulence of the oil flow in each dimple 3 is further suppressed. As a result, the pressure of the oil film can be efficiently increased by the dimples 3.

Referring to FIGS. 1 and 2, when forming dimples 3 on the processing surface 2, the rotary cutting tool 10, and hence the cutting edge 12 provided on the radially outer surface 11b of the tool main body 11, is rotated about the axis 11a. The rotary cutting tool 10 is fed along the processing surface 2 while rotating so as to form dimples 3 on the processing surface 2 utilizing the cutting edge 12. Each dimple 3 formed by the rotary cutting tool 10 has an aspect ratio of greater than or equal to 5.0 and less than or equal to 50.0, where the aspect ratio being a ratio of the length 3b in the longitudinal direction to the lateral width 3c in the lateral direction perpendicular to the longitudinal direction. Therefore, a plurality of dimples 3 having a relatively larger aspect ratio of greater than or equal to 5.0 can be easily formed in the processing surface 2. For example, it is possible to relatively easily form a plurality of dimples 3 arranged in parallel in the direction in which the workpiece 1 will move relative to the counterpart material.

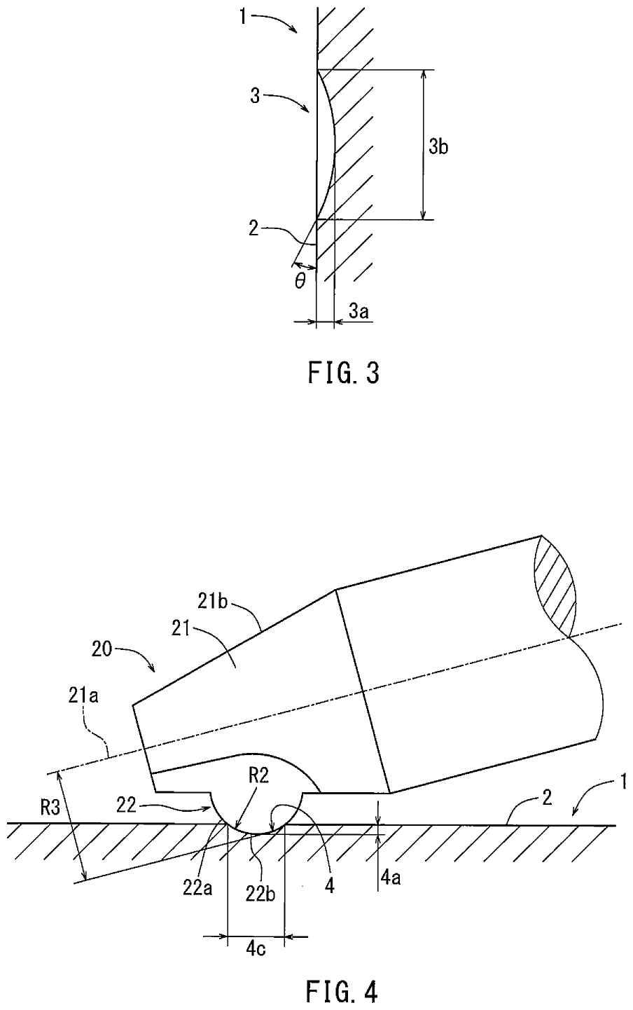

Another embodiment of a rotary cutting tool 20 and associated dimples 4 formed in a processing surface 2 will now be described with reference to FIGS. 4 to 6. In this embodiment, dimples 4 are formed with the rotary cutting tool 20 shown in FIG. 4, as opposed to the rotary cutting tool 10 shown in FIG. 1. The rotary cutting tool 20 includes a tool main body 21 with a central axis 21a and a cutting edge 22. Cutting edge 22 has a different geometry than the cutting edge 12 shown in FIG. 1. In this embodiment, the cutting edge 22 includes a bottom edge 22a.

As shown in FIG. 4, the bottom edge 22a has a circular arc shape projecting radially outward relative to the axis 21a from the tool main body 21. The location where the bottom edge 22a protrudes the most in the radial direction of the rotary cutting tool 20 is the leading end 22b of the cutting edge 22. The radius of curvature R2 of the bottom edge 22a is greater than or equal to 0.40 mm or more, for example, 0.50 mm. The maximum of R2 is, for example, 2 mm. The radial distance R3 measured radially from the axis 21a to the leading end 22b is greater than or equal to 10.0 mm, for example 12.5 mm. The maximum of R3 may be, for example, 30 mm. The ratio between the radial distance R3 and the radius of curvature R2 is greater than or equal to 25.0. The rake face of the cutting edge 22 is substantially semicircular and generally oriented in the circumferential direction of the tool main body 21.

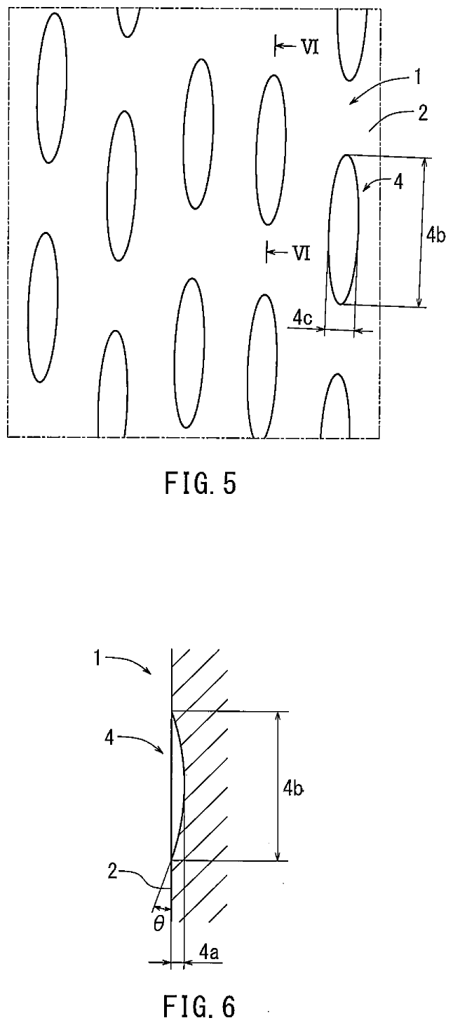

As shown in FIGS. 5 and 6, each dimple 4 formed on the processing surface 2 by the rotary cutting tool 20 has an elliptical shape. The maximum depth 4a of the dimple 4 may range from 3 to 7 e.g., 5 μm. The length 4b of the dimple 4 in the longitudinal direction may range from 0.10 to 1.00 mm, for example 0.20 mm. The lateral width 4c measured perpendicular to the longitudinal direction of the dimple 4 may be, for example, 0.010 mm, so that the aspect ratio (the ratio of the length 4b to the lateral width 4c) is greater than or equal to 5.0 and less than or equal to 50.0. The longitudinal ends of the dimple 4 have a gentle inclination angle θ of 10.0° or less measured downward from the processing surface 2 in the depth direction. Each of the plurality of dimples 4 are arranged at predetermined intervals in the longitudinal direction. The interval in the longitudinal direction of the plurality of dimples 4 may be, for example, 0.30 mm, and in some embodiments, is longer than the length 4b.

As shown in FIG. 5, a plurality of dimples 4 are formed on the workpiece 1 to increase the pressure of the oil film disposed between the processing surface 2 and a counterpart material. Each dimple 4 has an aspect ratio of greater than or equal to 5.0 and less than or equal to 50.0, where the aspect ratio is the ratio of the length 4b measured in the longitudinal direction to a lateral width 4c measured in a direction perpendicular to the longitudinal direction. The dimple 4 has an elliptical shape elongated in the longitudinal direction. Therefore, the dimples 4 may exhibit a similar effect as the dimples 3 of the first embodiment. As a result, vortex-like turbulence can be suppressed and/or prevented from being generated in the oil flow in the dimples 4.

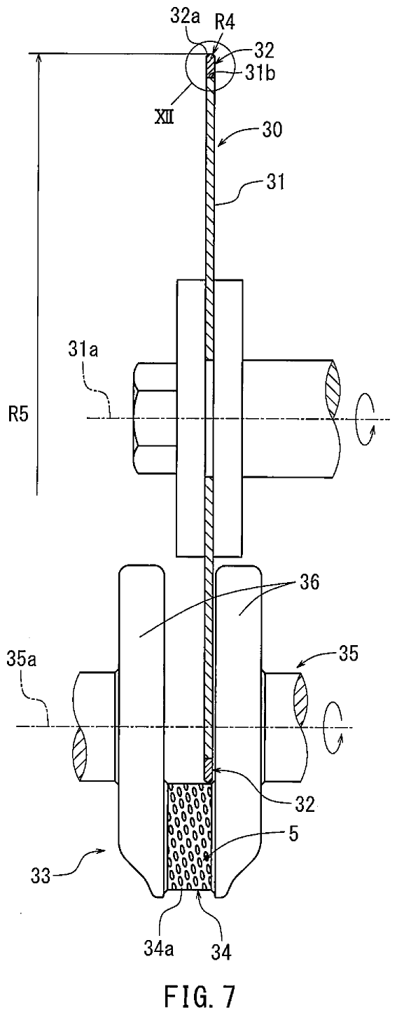

Another embodiment of a rotary cutting tool 30 and associated dimples 5 will now be described with reference to FIGS. 7 to 10 and 12. In this embodiment, the dimples 5 are formed with the rotary cutting tool 30 on a radially outer cylindrical surface of a columnar shaped member. For example, a plurality of ellipse shaped dimples 5 are formed on a radially outer cylindrical surface 34a of the crankpin 34 of the crank shaft 33.

As shown in FIGS. 7, 8, and 12, the rotary cutting tool 30 includes a disc-shaped tool main body 31 having a central axis 31a and a plurality of cutting edges projecting radially outward from the radially outer surface 31b of the tool main body 31. Each cutting edge 32 has a circular arc-shaped bottom edge 32a that projects radially from the outer periphery of the tool body 31. The tool body 31 may have a diameter of, for example, 320.0 mm and a thickness of 4.0 mm. The circular arc shape of each bottom edge 32a may have, for example, a fan shape having an angle in the range of 160° in the thickness direction. The circular arc shaped radius of curvature R4 of the bottom edge 32a may be, for example, 2.35 mm.

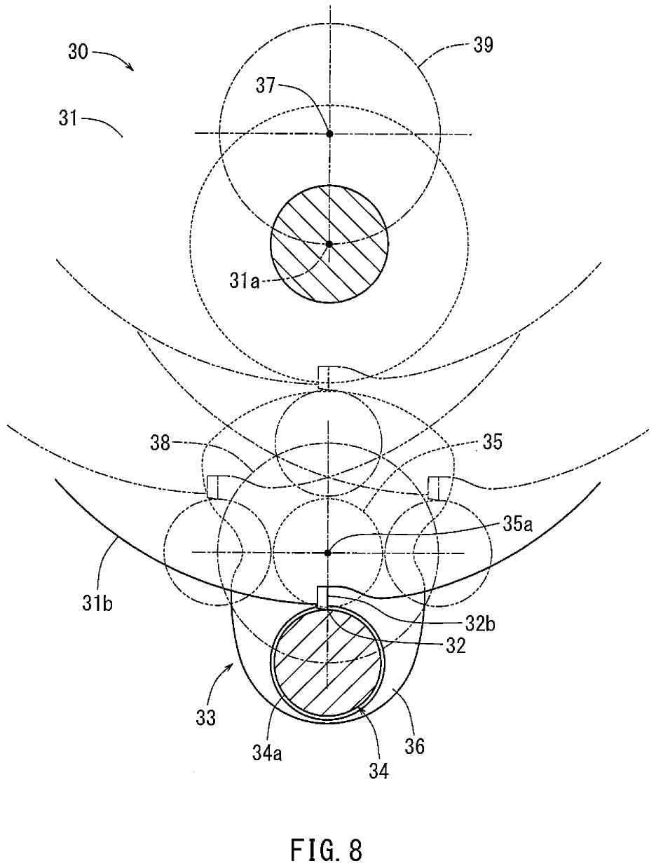

As shown in FIGS. 7 and 8, the ratio of the radius R5 of the tool main body 21 to the radius of curvature R4 of the bottom edge 32a is greater than or equal to 25.0 or more. The tool main body 31 may have one or a plurality of cutting edges 32. If a plurality of cutting edges 32 are provided, they may be arranged on the outer surface 31b of the tool main body 31 at intervals, for example, at uniformly circumferentially-spaced positions on the outer surface 31b. The rake face 32b of the cutting edge 32 is oriented in substantially the circumferential direction of the tool main body 31.

Referring to FIGS. 7 and 8, the process of forming dimples 5 using the rotary cutting tool 30 is illustrated. The crankshaft 33 includes a crank journal 35, a crankpin 34, and a crank arm 36. The crankpin 34 has a cylindrical shape with a central axis oriented parallel to the central axis 35a of the crank journal 35. The pair of crank arms 36 extend radially from the crank journal 35 to the crankpin 34 with the crankpin 34 located at the leading end thereof. As a result, the central axis of the crankpin 34 is radially spaced apart from the central axis 35a of the crank journal 35. The crankshaft 33 is supported so as to be rotatable about an axis 35a. As the crankshaft 33 rotates, the axis of the crankpin 34 moves along a circular path 38.

Referring to FIGS. 7 and 8, the rotary cutting tool 30 is rotatably supported and configured to rotate about the axis 31a, which is oriented parallel to the axis 35a of the crank shaft 33. The rotary cutting tool 30 is supported such that the axis 35a moves on the circular path 39 about the tool revolving shaft 37. The crankpin 34 revolves about the axis 35a when the crank shaft 33 rotates about the axis 35a. The rotary cutting tool 30 revolves about the tool revolving shaft 37 on the circular path 39 so as to be synchronized to be similarly parallel to the revolving of the crankpin 34 along the circular path 38.

Referring to FIGS. 7 and 8, the distance of the rotary cutting tool 30 from the outer surface 34a may be set based on the desired maximum depth 5a of the dimple 5 (see FIG. 10). The distance of the rotary cutting tool 30 from the outer surface 34a may be set so as to have the maximum depth 5a ranging from 3 to 7 μm, e.g., 5 μm. During cutting, the axis 31a of the rotary cutting tool 30 rotates about the axis 31a and moves along the circular path 39 in accordance with the crankpin 34, which moves on the circular path 38. Further, the rotary cutting tool 30 moves relative to the outer surface 34a in the direction of the axis 31a. Thereby, a plurality of the dimples 5 are formed so as to be longitudinally aligned in the circumferential direction of the outer surface 34a, and circumferentially-spaced apart from each other in the circumferential direction and axially spaced apart in the axial direction of the outer surface 34a.

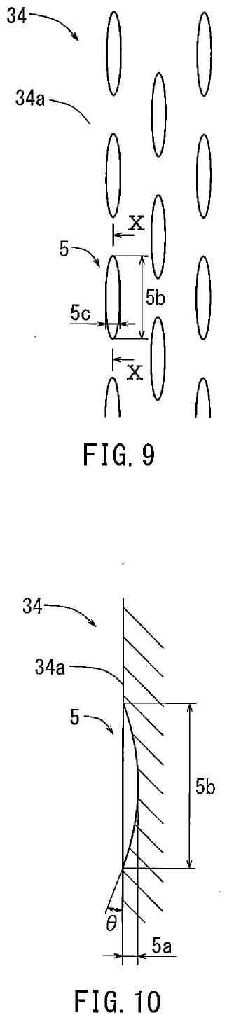

As shown in FIGS. 9 and 10, the dimples 5 formed on the outer surface 34a have an elliptical shape. The maximum depth 5a of the dimple 5 may range from 3 to 7 μm, e.g., 5 μm. The length 5b in the longitudinal direction of the dimple 5 may be, for example, 0.970 mm. The lateral width 5c of the dimple 5 measured perpendicular to the longitudinal direction may be, for example, 0.0569 mm, so that the dimple 5 may have an aspect ratio (a ratio of the length 5b to the lateral width 5c) of greater than or equal to 5.0 and less than or equal to 50.0. The longitudinal ends of the dimple 5 incline downwards from outer surface 34a at an inclination angle θ of 10.0° or less measured relative to the outer surface 34a in the depth direction. The longitudinal intervals between the plurality of the dimples 5 may be, for example, 1.50 mm, which in some embodiments is longer than or substantially the same as the length 5b.

As shown in FIG. 9, the plurality of the dimples 5 are formed on the outer surface 34a of the crankpin 34 to increase the pressure of an oil film disposed between outer surface 34a and a counterpart material. The dimples 5 have an aspect ratio greater than or equal to 5.0 and less than or equal to 50.0, where the aspect ratio is a ratio of the length 5b measured in the longitudinal direction to the lateral width 5c measured in a direction perpendicular to the longitudinal direction. The dimples 5 have an elliptical shape elongated in the longitudinal direction. Therefore, the dimples 5 may exhibit the same effect as the previously described dimples 3. For example, vortex-like turbulence may be suppressed or prevented from being generated in the oil flow in the dimples 5. The oil flow in the dimples 5 primarily corresponds to the longitudinal direction of the dimples 5. The pressure of the oil film between the crankpin 34 and the connecting rod can thus be efficiently increased, especially since the longitudinal direction of the dimples 5 extends along the direction of relative motion between the crankpin 34 and a connecting rod (in the circumferential direction of the outer surface 34a).

Another embodiment will now be described with reference to FIG. 13. In this embodiment, a cutting edge 42 shown in FIG. 13 is provided on the radially outer surface 31b of the tool main body 31. As shown in FIG. 13, the cutting edge 42 has a first bottom edge 42a and a second bottom edge 42b. The first bottom edge 42a is a planar surface, which is inclined by a predetermined angle with respect to the radial direction and the axial direction of the tool main body 31. The second bottom edge 42b is a planar surface, which is inclined by a predetermined angle with respect to the radial direction and the axial direction of the tool main body 31, and intersects with the first bottom edge 42a at a predetermined angle. The first bottom edge 42a and the second bottom edge 42b intersect to form a V-shaped leading end 42c. Specifically, the cutting edge 42 has substantially a triangular shaped rake face. The rake face of the cutting edge 42 is oriented in substantially the circumferential direction of the tool main body 31. The cutting edge 42 has a flank on the opposite side of the rake face.

The spindle shaped dimples, as shown in FIGS. 2 and 3, are formed on the outer surface 34a of the crankpin 34 of the crank shaft 33 shown in FIG. 7 using the cutting edge 42 shown in FIG. 13. The maximum depth of the dimples 5 formed on the outer surface 34a shown in FIG. 7 may range from 3 to 7 μm, e.g., 5 μm. The length 5b of the dimples 5 measured in the longitudinal direction may be, for example, 0.970 mm. The lateral width measured perpendicular to the longitudinal direction of the dimples 5 may be, for example, 0.020 mm, so that the dimples 5 may have an aspect ratio (a ratio of the length 5b to the lateral width 5c) of greater than or equal to 5.0 or more and less than or equal to 50.0. The longitudinal ends of the dimples 5 have a gentle inclination angle of 10.0° or less measured downward from the outer surface 34a in the depth direction. The intervals in the longitudinal direction of the plurality of the dimples 5 may be, for example, 1.50 mm, which in some embodiments is longer than or substantially the same as the length 5b.

The spindle shaped dimples are formed on the outer surface 34a of the crankpin 34 of the crank shaft 33 shown in FIG. 7 using the cutting edge 42 shown in FIG. 13. The aspect ratio of the length 5b in the longitudinal direction to the lateral width 5c perpendicular to the longitudinal direction is greater than or equal to 5.0 and less than or equal to 50.0. The dimples 5 have a spindle shape elongated in the longitudinal direction. Therefore, the dimples 5 formed by the cutting edge 42 exhibit the same effect as the previously described dimples 5. Namely, the pressure of the oil film between the crankpin 34 and the connecting rod can thus be efficiently increased, especially since the longitudinal direction of the dimples extends along the direction of relative motion between the crankpin 34 to the counterpart material (connecting rod) (in the circumferential direction of the outer surface 34a).

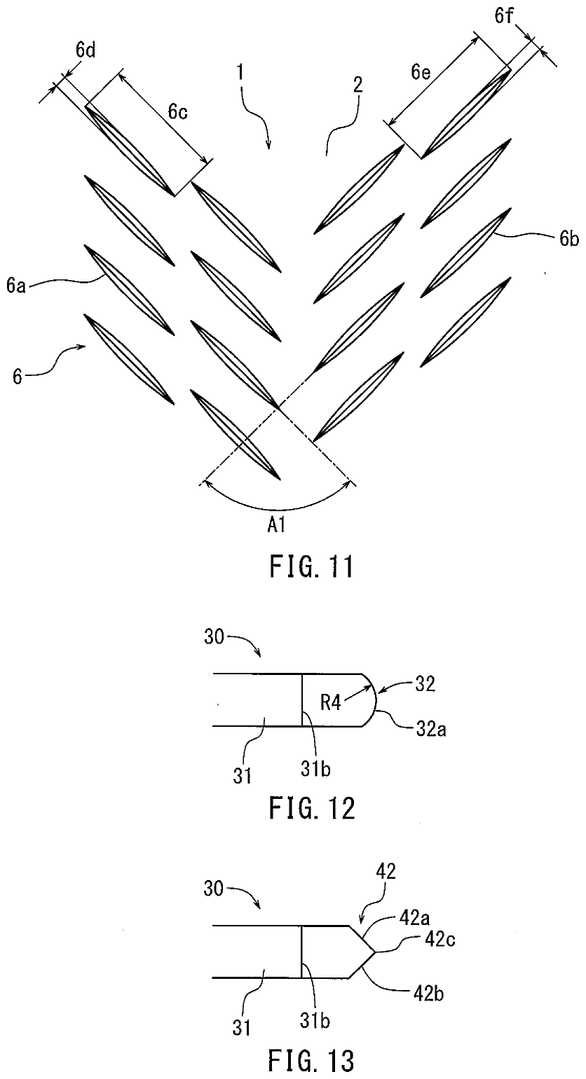

Another embodiment will now be described with reference to FIG. 11. In this embodiment, the dimples 6 shown in FIG. 11 are formed on the processing surface 2 of the workpiece 1. The dimples 6 may be formed, for example, using the rotary cutting tool 10 shown in FIG. 1 or the rotary cutting tool 20 shown in FIG. 4. The dimples 6 include a plurality of first dimples 6a and a plurality of second dimples 6b. As shown in FIG. 11, in this embodiment, the first dimples 6a and the second dimples 6b have a spindle shape. In other embodiments, the first dimples 6a and the second dimples 6b may have an elliptical shape. The regions where the first dimples 6a and the second dimples 6b are formed do not substantially overlap each other.

As shown in FIG. 11, the maximum depth of each of the first dimples 6a and the second dimples 6b may range from 3 to 7 μm, e.g., 5 μm. The length 6c of each first dimple 6a measured in along the longitudinal direction of the first dimple 6a and the length 6e of each second dimple 6b measured in the longitudinal direction of the second dimple 6b may range from 0.10 to 1.00 mm, for example, 0.20 mm. The lateral width 6d measured perpendicular to the longitudinal direction of each first dimple 6a and the lateral width 6f of each second dimple 6b measured perpendicular to the longitudinal direction of the second dimple 6b may be, for example, 0.010 mm, so that each dimple 6a, 6b has an aspect ratio (a ratio of the length 6c, 6e to the lateral width 6d, 6f, respectively) that is greater than or equal to 5.0 and less than or equal to 50.0. The longitudinal ends of the first dimples 6a and the second dimples 6b have a gentle inclination angle of 10.0° or less measured downward from the processing surface 2 in the depth direction.

As shown in FIG. 11, the longitudinal directions of the plurality of the first dimples 6a are parallel to each other, and the longitudinal directions of the plurality of the second dimples 6b are parallel to each other. The first dimples 6a and the second dimples 6b may be arranged so that their longitudinal directions intersect with each other at an angle A1. The angle A1 may be, for example, 90°. Each first dimple 6a is spaced apart from each adjacent first dimple 6a, and each second dimple 6b is spaced apart from each adjacent second dimple 6b.

As shown in FIG. 11, the plurality of the dimples 6 are formed on the workpiece 1 to increase the pressure of the oil film positioned between the workpiece 1 and a counterpart material. The plurality of the dimples 6 includes the plurality of the first dimples 6a and the plurality of the second dimples 6b. The first dimples 6a have an aspect ratio greater than or equal to 5.0 and less than or equal to 50.0, where the aspect ratio is a ratio of the length 6c in the longitudinal direction to the lateral width 6d in a direction perpendicular to the longitudinal direction. The second dimples 6b have an aspect ratio between greater than or equal to 5.0 and less than or equal to 50.0, where the aspect ratio is a ratio of the length 6e in the longitudinal direction to the lateral width 6f in a direction perpendicular to the longitudinal direction. The dimples 6 have a spindle shape or an elliptical shape elongated in the longitudinal direction. Therefore, vortex-like turbulence may be reduced and/or prevented from being generated in the oil flow in the dimples 6. Further, the oil flow in the dimples 6 will be a less turbulent flow along the longitudinal direction of the dimple 6. Therefore, a reduction in the oil film pressure due to the turbulence of the oil flow in the dimples 6 may be suppressed.

As shown in FIG. 11, the dimples 6 include the plurality of first dimples 6a oriented parallel to each other and the plurality of second dimples 6b oriented parallel to each other. The plurality of first dimples 6a and the plurality of second dimples 6b may be arranged so that the longitudinal direction of the plurality of first dimples 6a and the longitudinal direction of plurality of the second dimples 6b intersect at angles A1. Therefore, the oil may more easily flow around the first dimples 6a along the longitudinal direction of the first dimples 6a, and the oil may also more easily flow around the second dimples 6b along the longitudinal direction of the second dimples 6b. Therefore, the oil flow around the first dimples 6a and the flow around the second dimples 6b may converge. Due to the convergence of the oil flow, the likelihood of the oil captured between the workpiece 1 and the counterpart material flowing out from between these components is reduced, thereby maintaining substantially all the oil therebetween. The pressure at the converged parts is increased more than the case of using a single dimple direction.

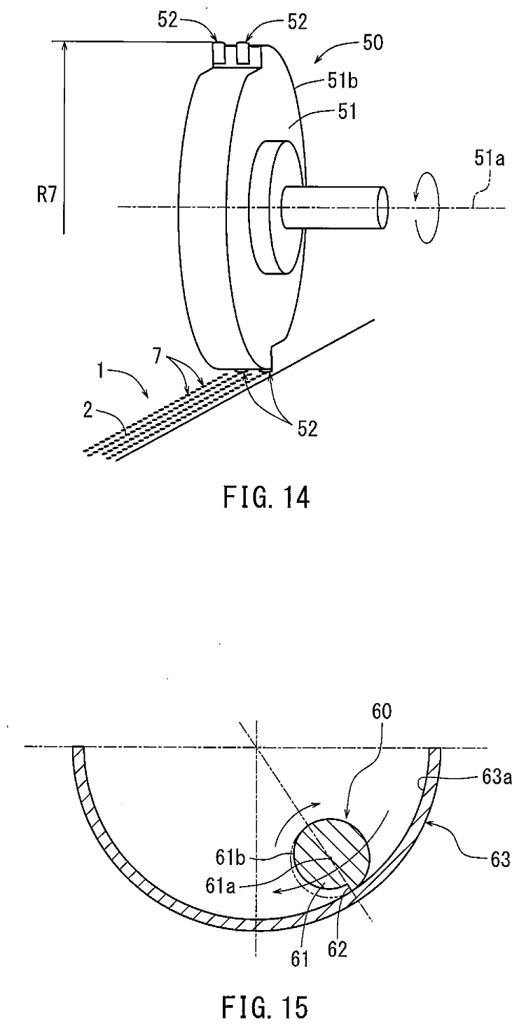

Another embodiment will be described with reference to FIG. 14. In this embodiment, a rotary cutting tool 50 shown in FIG. 14 is used, instead of the rotary cutting tool 30 shown in FIG. 7. Dimples 7 are formed on the processing surface 2 of the workpiece 1 using the rotary cutting tool 50. The rotary cutting tool 50 includes a cylindrical tool main body 51 having a central axis 51a and a plurality of cutting edges 52 projecting radially outward from the radially outer surface 51b of the tool main body 51. The plurality of the cutting edges 52 are arranged so as to be spaced apart in the axial direction (parallel to axis 51a) and circumferential direction (about axis 51a) of the tool body 51. For example, the plurality of cutting edges 52 are spaced apart in the axial direction by a distance substantially equal to the length of the cutting edge 52 in the axial direction. Further, the plurality of the cutting edges 52 are spaced apart from each other, for example, by 180° in the circumferential direction.

The cutting edges 52 shown in FIG. 14 may have, for example, a shape similar to the cutting edge 32 shown in FIG. 12 or a shape similar to the cutting edge 42 shown in FIG. 13. The distance of the rotary cutting tool 50 from the processing surface 2 is set such that the maximum depths of the dimples 7 may range from 3 to 7 μm, e.g., 5 μm. The rotary cutting tool 50 is rotated about the axis 51a and moved relative to the processing surface 2 in the cutting direction of the cutting edges 52. This allows the plurality of the dimples 7 on the processing surface 2 to be arranged parallel to each other in the longitudinal direction and spaced apart from each other. The dimples 7 formed by the cutting edges 52 may have, for example, an elliptical shape or a spindle shape.

As shown in FIG. 14, the maximum depths of the dimples 7 may instead be 8 to 12 μm, e.g., 10 μm. The lengths of the dimples 7 in the longitudinal direction may be, for example, 4.0 mm. The lateral width of the dimples 7 perpendicular to the longitudinal directions may be, for example, 0.50 mm, so that the dimples 7 have an aspect ratio (a ratio of the length to the lateral width) of greater than or equal to 5.0 and less than or equal to 50.0. The longitudinal ends of the dimples 7 may have a gentle inclination angle of 10.0° or less measured downward from the processing surface 2 in the depth direction.

As shown in FIG. 14, the plurality of the dimples 7 are formed on the workpiece 1 to increase the pressure of the oil film between the workpiece 1 and a counterpart material. The dimples 7 have an aspect ratio greater than or equal to 5.0 and less than or equal to 50.0, where the aspect ratio is a ratio of the length in the longitudinal direction to the lateral width in a direction perpendicular to the longitudinal direction. The dimples 7 may have a spindle shape or an elliptical shape elongated in the longitudinal direction, and are arranged parallel to each other in the longitudinal direction. Therefore, the dimples 7 may exhibit a similar effect as the previously described dimples 3. For example, vortex-like turbulence may be reduced and/or prevented from being generated in the oil flow in the dimples 6. The rotary cutting tool 50 can simultaneously form a plurality of rows of dimples 7 spaced apart from each other in the direction of the axis 51a.

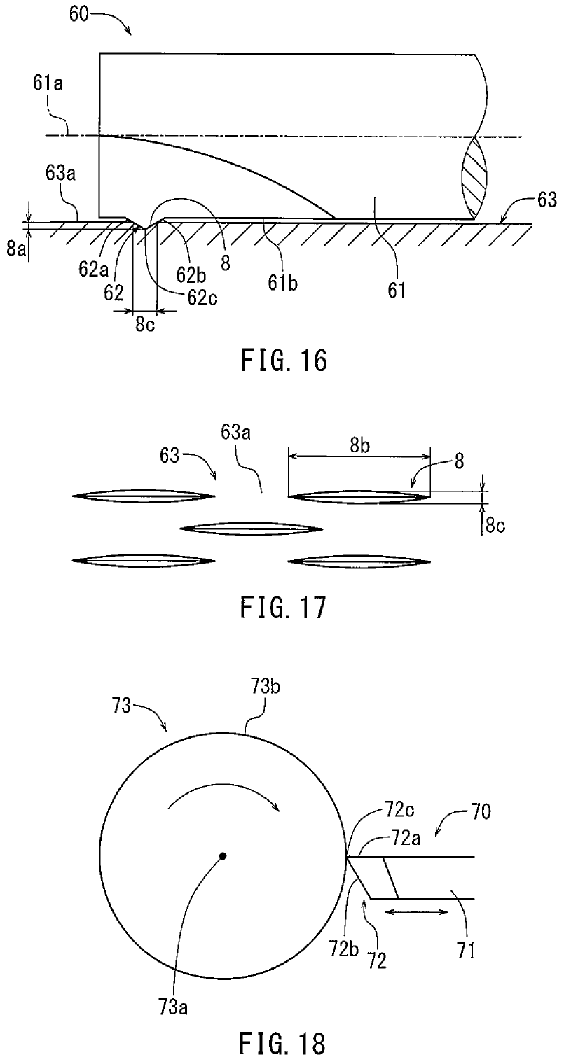

Another embodiment will be described with reference to FIGS. 15 to 17. In this embodiment, a rotary cutting tool 60 shown in FIGS. 15 and 16 is used, instead of the rotary cutting tool 10 shown in FIG. 1. The dimples 8 are formed on an inner cylindrical surface 63a of a cylindrical workpiece 63 using the rotary cutting tool 60. The rotary cutting tool 60 includes a tool main body 61 with a central axis 61a and one or a plurality of cutting edge(s) 62 projecting radially outward from a radially outer surface 61b of the tool main body 61. If a plurality of the cutting edges 62 are provided, they may be arranged on the outer surface 61b of the tool main body 61 at intervals in a circumferential direction, for example, at equidistant positions on the outer surface 61b in the circumferential direction. Alternatively or in addition, they may be arranged at predetermined intervals in the axial direction.

As shown in FIG. 16, the cutting edge 62 has a first bottom edge 62a and a second bottom edge 62b. The first bottom edge 62a is an edge having substantially a flat end, which is inclined at a predetermined angle with respect to the radial direction and the axial direction of the tool main body 61. The second bottom edge 62b is an edge that is inclined by a predetermined angle with respect to the radial direction and the axial direction of the tool main body 61, and intersects with the first bottom edge 62a by a predetermined angle. The first bottom edge 62a and the second bottom edge 62b intersect to form a V-shaped leading end 62c. Specifically, the cutting edge 62 has substantially a triangular shaped rake face. The rake face of the cutting edge 62 is oriented in substantially the circumferential direction of the tool main body 61.

As shown in FIGS. 15 and 16, the rotary cutting tool 60 is rotated about the axis 61a while moving along the inner surface 63a. Thereby, the cutting edges 62 cut the inner surface 63a to form a plurality of the spindle shaped dimples 8. The dimples 8 are spaced apart from each other along the circumferential direction of the inner surface 63a. The longitudinal direction of each dimple 8 is the same direction as the circumferential direction of the inner surface 63a. Further, the dimples 8 are arranged so as to be spaced apart from and parallel to each other in the axial direction of the workpiece 63. This is accomplished by moving the rotary cutting tool 60 in the axial direction (i.e., parallel to the axis 61a.

As shown in FIGS. 16 and 17, the maximum depth 8a of the dimple 8 may range from 3 to 7 μm, e.g., 5 μm. The length 8b of the dimple 8 in the longitudinal direction may be, for example, 0.557 mm. The lateral width 8c of the dimple 8 perpendicular to the longitudinal direction may be, for example, 0.020 mm, so that the dimple 8 may have an aspect ratio (a ratio of the length 8b to the lateral width h 8c) greater than or equal to 5.0 and less than or equal to 50.0. The longitudinal ends of the dimples 8 have a gentle inclination angle of 10.0° or less measured downward from the inner surface 63a in the depth direction. When the rotary cutting tool 60 has, for example, a circular arc shaped cutting edge as shown in FIG. 4, alternative to the cutting edge 62, ellipse shaped dimples may be formed on the inner surface 63a, similar to the previously described dimples 8.

As shown in FIGS. 15 to 17, the plurality of dimples 8 are formed on the workpiece 1 in order to increase the pressure of the oil film between the workpiece 1 and a counterpart material. The dimples 8 may have an aspect ratio of greater than or equal to 5.0 and less than or equal to 50.0, the aspect ratio being a ratio of the length 8b in the longitudinal direction to the lateral width 8c in a direction perpendicular to the longitudinal direction. The dimples 8 may have an elliptical shape or a spindle shape elongated in the longitudinal direction and may be arranged parallel to each other in the longitudinal direction. Therefore, the dimples 8 may exhibit a similar effect as the previously described dimples 3. For example, vortex-like turbulence can be reduced and/or prevented from being generated in the oil flow in the dimples 8.

Another embodiment will now be described with reference to FIG. 18. In this embodiment, dimples are formed on a processing surface 73b of a workpiece 73 having substantially a cylindrical shape, a conical shape, or other rotatable body shape using a bit 70 shown in FIG. 18. The bit 70 includes a rod-like tool main body 71 and a cutting edge 72 disposed on the leading end of the tool main body 71. The cutting edge 72 has a rake face 72a and a flank 72b.

As shown in FIG. 18, the workpiece 73 is rotatably supported about a central axis 73a. The processing surface 73b is cut by abutting the leading end 72c of the cutting edge 72 to the processing surface 73b of the workpiece 73 rotating about the axis 73a. The leading end 72c of the cutting edge 72 is repeatedly abutted to and moved away from the processing surface 73b as the bit 70 reciprocally moves in the radial direction of the workpiece 73. As a result, the plurality of the dimples can be formed on the processing surface 73b by the cutting edges 72. The plurality of the dimples are arranged so that the longitudinal direction is arranged along the circumferential direction of the processing surface 73b and are spaced apart from each other. The bit 70 moves relative to the workpiece 73 in a radial direction toward the axis 73a. This allows the plurality dimples to be arranged parallel to the axis 73a direction and spaced apart from each other.

The maximum depth of the dimples formed on the processing surface 73b shown in FIG. 18 may range from 3 to 7 μm, e.g., 5 μm. The length of the dimple in the longitudinal direction may range from 0.10 to 1.00 mm, e.g., 0.20 mm. The lateral width perpendicular to the longitudinal direction of the dimple may be, for example, 0.010 mm, so that the dimples have an aspect ratio (a ratio of the length to the lateral width) of greater than or equal to 5.0 and less than or equal to 50.0. The longitudinal ends of the dimples have a gentle inclination angle of 10.0° or less measured downward from the processing surface 2 in the depth direction.

As shown in FIG. 18, the plurality of the dimples are formed on the processing surface 73b of the workpiece 73 in order to increase the pressure of the oil film between the processing surface 73b and a counterpart material. Each dimple has an aspect ratio of greater than or equal to 5.0 and less than or equal to 50.0, where the aspect ratio is a ratio of the length in the longitudinal direction to the lateral width measured perpendicular to the longitudinal direction. The dimples are arranged so as to be spaced away from and parallel to each other in the longitudinal direction. Therefore, the dimples formed on the processing surface 73b exhibit a similar effect as the previously described dimples 3. For example, vortex-like turbulence may be reduced and/or prevented from being generated in the oil flow in the dimples.

Hereinafter, the experiments and their results as a basis for defining the dimple shape will be presented. As one of the experiments, frictional characteristics of the processing surface of the workpiece were evaluated by a three ball-on-disc type friction test apparatus. The workpiece used was a disc-shaped aluminum alloy for casting (AC8A-T6) having an outer diameter of 44 mm, an inner diameter of 20 mm, and a thickness of 8 mm. A chrome bearing steel (SUJ2) ball having a diameter of 6.35 mm was used as a friction counterpart material. The counterpart material was polished so that the contact surface with the workpiece had a diameter of 2.5 mm, and was mirror-finished so that the surface roughness (arithmetic mean roughness) of the contact surface was 0.01 μm or less.

The three counterpart materials were placed at respective trisection positions in the circumferential direction at a position 17 mm from the center of the workpiece. A poly-α-olefin-based synthetic lubricating oil (PAO) of 10 cst at 40° C. was applied on the contact surface between the workpiece and the counterpart material. A load was applied to the three counterpart materials from a side opposite to the contact surface. The total load applied to the three counterpart materials was increased from 50 N to 450 N in 25 N increments. The workpiece was rotated about the central axis so that the sliding speed was 2.0 m/sec, while the load was applied to the counterpart material. The coefficient of friction between the workpiece and the counterpart material was obtained by calculating using the load applied to the counterpart material and the torque required to rotate the workpiece.

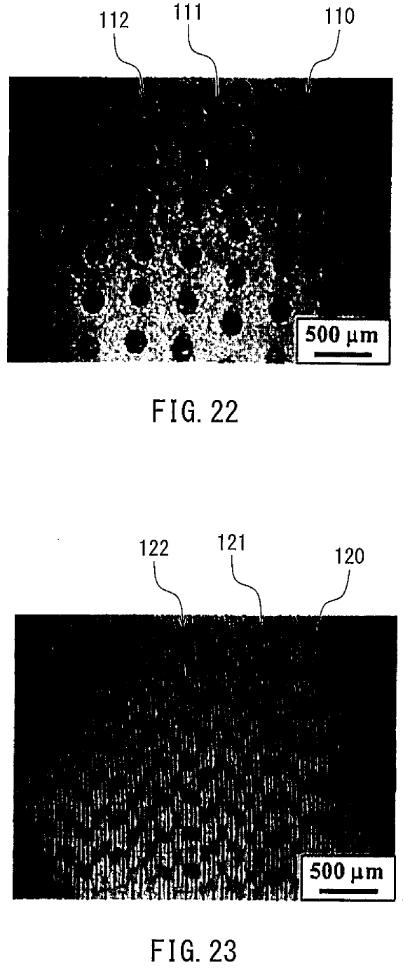

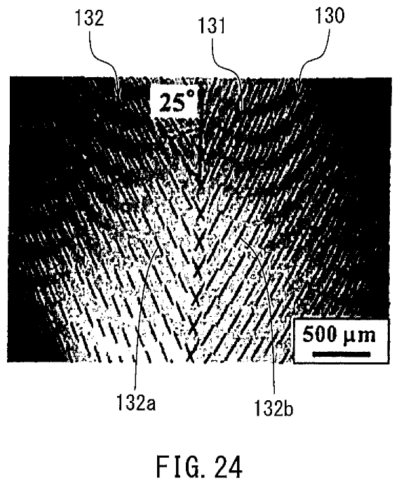

The following test pieces were prepared. The first test piece 100 was a workpiece on which no dimple was formed. A second test piece 110, which is shown in FIG. 22, was a workpiece on which circular dimples 112 were formed on a processing surface 111. A third test piece 120, which is shown in FIG. 23, was a workpiece on which spindle-shaped dimples 122 were formed on a processing surface 121. A fourth test piece 130, shown in FIG. 24, was a workpiece on which spindle-shaped dimples 132 were formed on a processing surface 131. The dimples 132 of the fourth test piece 130 had a plurality of first dimples 132a arranged in parallel and a plurality of second dimples 132b arranged in parallel. The first dimples 132a and the second dimples 132b were arranged so that their longitudinal directions intersected each other at an angle of about 25°. The dimples 132 were arranged such that the moving direction of the counterpart material with respect to the test piece 130 corresponded to a direction in which the first dimples 132a and the second dimples 132b intersect and converge. For example, in FIG. 24, the direction from top to bottom was the direction of movement of the counterpart material relative to the test piece 130. The number of dimples and the intervals of each of the test pieces 110, 120, 130 were set so that the area ratio occupied by the dimples on the sliding surface was equal to 15%.

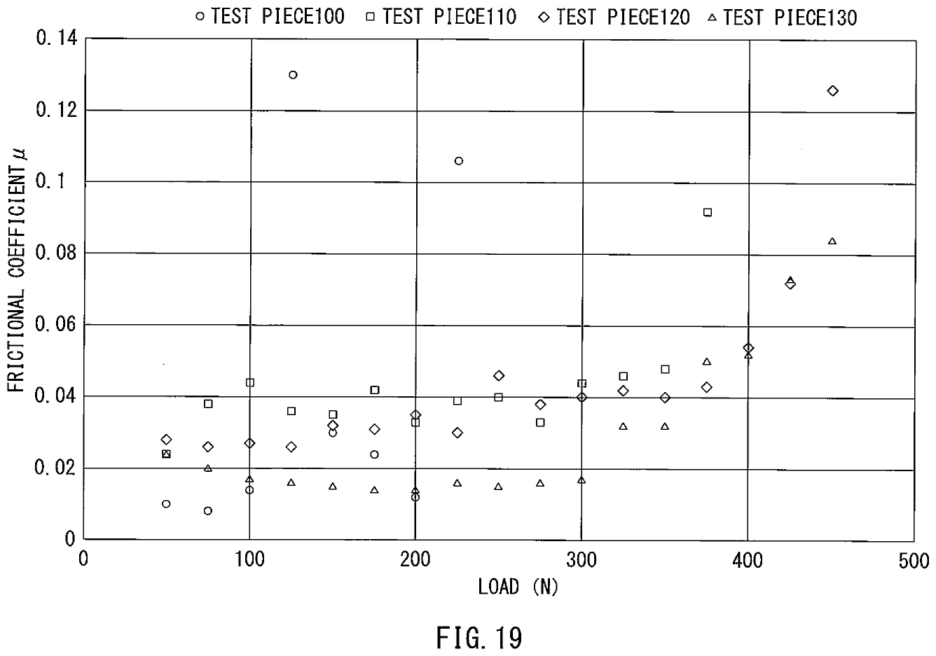

As shown in FIG. 19, in the case of the test piece 100 in which no dimples were formed, the frictional coefficient changed from about 0.01 to about 0.13. Seizure occurred when the load reached 12 5N. In the case of the second test piece 110, the frictional coefficient was larger than that of the first test piece 100. This occurred at a low load, 200 N or less. However, the change in the frictional coefficient accompanied by the increase in load was gradual, about 0.03 to 0.05, until the load resistance was 375 N. It is believed that the frictional coefficient stabilized in the second test piece 110 because the dimples 112 served as spots where wear debris or oil could accumulate. It is believed that the frictional coefficient increased at low load because turbulence of the oil flow in the dimples 112 was generated and the pressure of the oil film decreased.

As shown in FIG. 19, in the case of the third test piece 120, the load resistance was increased to 450 N. The frictional coefficient under the same load was reduced, by about 0.01 to 0.04, as compared to the case of the second test piece 110. In the case of the fourth test piece 130, the frictional coefficient was reduced, by about 0.02, as compared to the third test piece 120, particularly at a low load of 100 to 300 N. This reduction may be caused by an increase in thickness of the oil film, since the first plurality of dimples 132a and the second plurality of dimples 132b were arranged with their longitudinal directions intersecting each other, so as to enhance the convergence of the oil. As a result, the contact frequency between the fourth test piece 130 and the ball decreased. The frictional coefficient increased to more than that of the first test piece 100 when the moving direction of the counterpart material with respect to the fourth test piece 130 was reversed. That is, the direction of movement of the counterpart material with respect to the fourth test piece 130 was directed from the bottom to the top of FIG. 24.

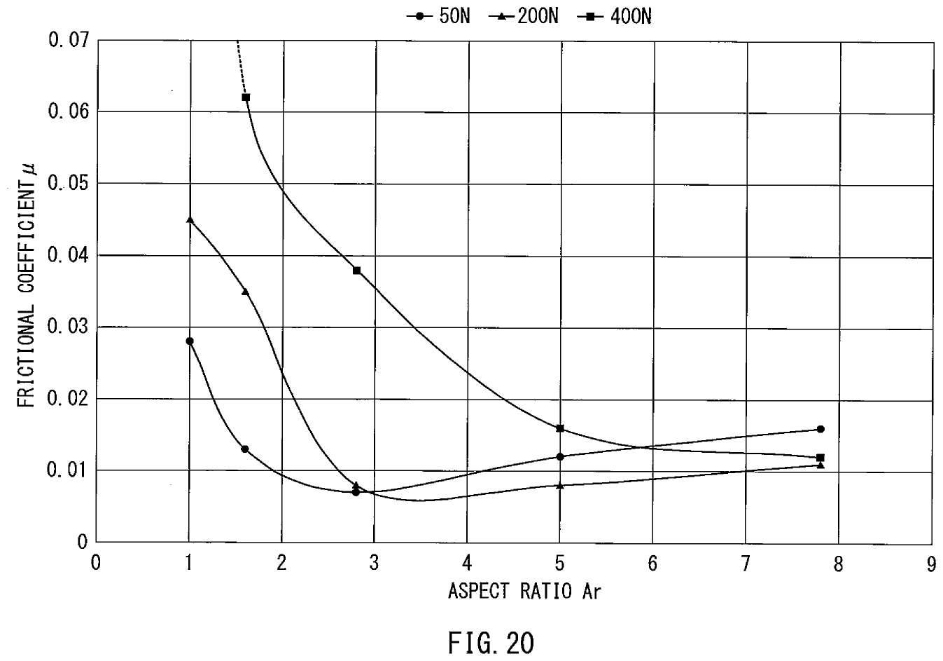

FIG. 20 shows the relationship between the aspect ratio Ar of the dimples and the frictional coefficient of the test pieces under a constant load, supported by the experimental results. The aspect ratio Ar was defined as the ratio of the length in the longitudinal direction to the lateral width in the direction perpendicular to the longitudinal direction. As shown in FIG. 20, when the aspect ratio Ar was 1 to 3, the frictional coefficient increased at high load. When the aspect ratio Ar was 5.0 or more, the frictional coefficient was small at both high load and low load.

The load changes in response to the rattle caused when two relatively sliding objects, for example, a cylindrical bearing and a columnar shaft in the bore of the bearing, slide. The frictional coefficient is reduced by forming dimples on one or both of the two objects. As shown in FIG. 20, by setting the aspect ratio Ar of the dimples to 5.0 or more, the frictional coefficient can be kept small, regardless of the change in load. Thus, the relative movement of the two objects becomes more stable.

If the aspect ratio Ar increases, while keeping the length in the longitudinal direction of the dimple substantially constant, an area of the dimple reduces. In order to maintain the dimple area ratio over the entire processing surface at a certain ratio, for example, 15% of coverage or more, it is necessary to form a larger number of dimples if the aspect ratio Ar is increased. Therefore, it is preferable that the aspect ratio Ar has an upper limit of 50.0.

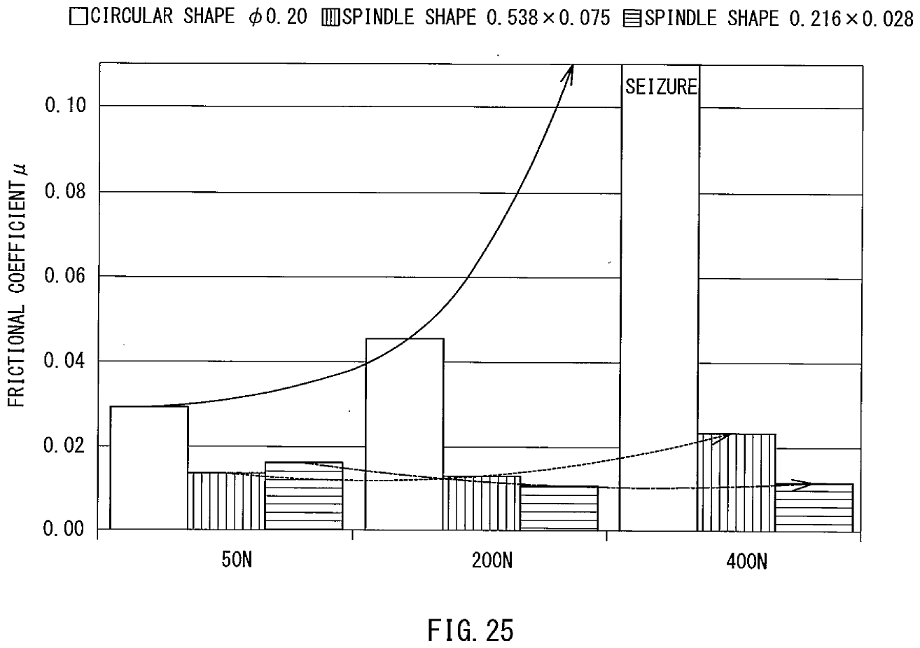

FIG. 25 shows the relationship between the load and the frictional coefficient for three workpieces, such as a workpiece provided with circular dimples and two workpieces provided with spindle-shaped dimples. The spindle-shaped dimples formed on two of the workpieces had an aspect ratio of 5.0 or more. The spindle-shaped dimples of the two workpieces had different lengths in the longitudinal direction. First, the frictional coefficients were compared between the spindle-shaped dimples and the circular dimples. Regardless of the level of the load, the frictional coefficient of the workpieces with the spindle-shaped dimples was smaller, by about 0.01 to about 0.02, than that of the circular dimples. Next, the two workpieces with spindle-shaped dimples were compared. At low to medium loads of 50 to 200 N, there was almost no difference in the frictional coefficients, even though there was a difference in the lengths of the dimples in the longitudinal direction. In the workpiece with short dimples, having a length of 0.216 mm in the longitudinal direction, the frictional coefficient was almost the same at a high load of 400 N as the low-to-medium loads. In the workpiece with long dimples, having a length of 0.538 mm in the longitudinal direction, the frictional coefficient at a high load of 400N was larger than the frictional coefficient at the low-to-medium loads.

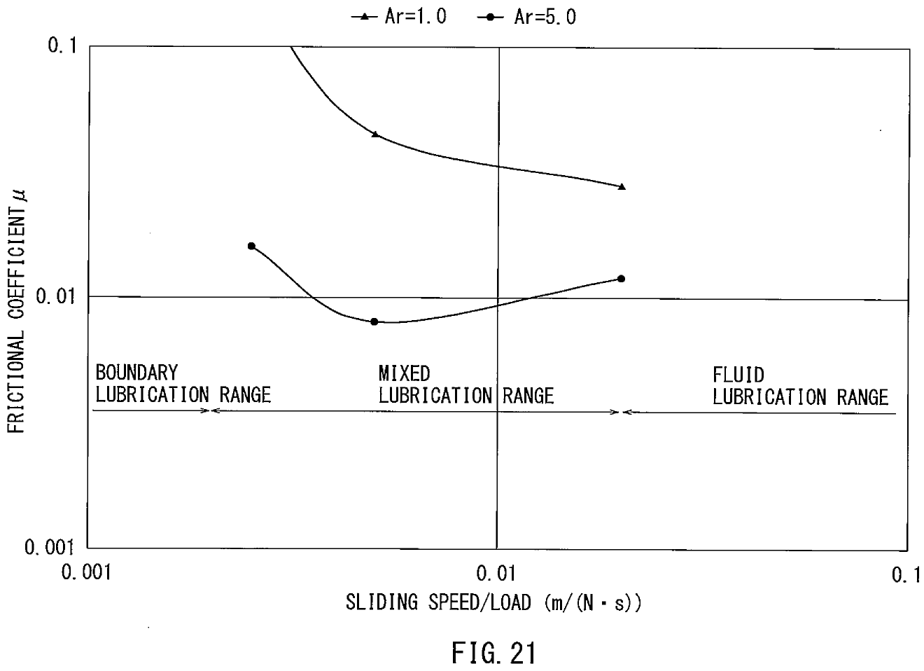

FIG. 21 is a plot of experimental results where the horizontal axis represents sliding speed/load (m/(N.$)) and the vertical axis represents the frictional coefficient. The sliding speed/load is an index of the thickness of the oil film between the workpiece and the counterpart material. The plot of the experimental results is within the mixed lubrication range. When the aspect ratio Ar was 5.0, the variation in the frictional coefficient with respect to the speed change was smaller than when the aspect ratio Ar was 1.0. For example, when the work piece slides with respect to the counterpart material at a substantially constant speed, the workpiece is generally used in the mixed lubrication range. For example, when a cylinder of a piston having a large relative speed change is used as a workpiece, the workpiece is used in a wide range of speeds, from the mixed lubrication range to the boundary lubrication range. Even in these cases, it has been shown that a workpiece with the dimples having an aspect ratio Ar of 5.0 exhibits a small change in the frictional coefficient and exhibits a stable behavior.

Various modifications may be made to the workpieces according to each of the embodiments described above. For example, as long as the aspect ratio Ar is greater than or equal to 5.0 and less than or equal to 50.0, a dimple having a rectangular shape or a rhombus shape may be formed on the processed surface of the workpiece. A rotary cutting tool with a cutting edge may have a leading end having a tapered shape, such as the leading end of the rotary cutting tool 10 shown in FIG. 1, or a substantially columnar shape, such as the leading end of the rotary cutting tool 60 shown in FIG. 16. The direction of rotation of the rotary cutting tool and the direction of movement of the workpiece may be selected appropriately. In other words, the dimple processing may be up-cut or down-cut. For example, regarding the plurality of dimples arranged in parallel in the longitudinal direction and the transverse direction, and regarding the sliding direction of the workpiece with respect to the counterpart material, the dimples may be formed such that the longitudinal direction of the dimples orthogonally intersects the sliding direction. The dimple processing method may be applied not only to a metal workpiece but also to a non-metal workpiece.

The various embodiments described above in detail with reference to the attached drawings are representative examples of the present invention but shall not limit the present invention. The detailed description teaches those skilled in the art to make, use, and/or practice various aspects of the present teachings and are not intended to limit the scope of the invention. Further, each additional feature and teaching described above may be applied to or used separately from and/or together with other features and teachings to provide an improved dimpled workpiece and/or a method of producing and using the same.

1. A workpiece having a surface, comprising:
a plurality of dimples on the surface, wherein the dimples are configured to increase a pressure of an oil film between the surface of the workpiece and a counterpart material, wherein:
each dimple has a length measured in a longitudinal direction of the dimple and a lateral width measured perpendicular to the longitudinal direction;
each dimple has an aspect ration equal to the ratio of the length of the dimple to the lateral width of the dimple,
the aspect ration of each dimples is greater than or equal to 5.0 and less than or equal to 50.0.

2. The workpiece of claim 1, wherein:
the plurality of the dimples includes a first plurality of dimples a second plurality of dimples;
the first plurality of dimples are oriented parallel to each other and the second plurality of dimples are oriented parallel to each other; and
the first plurality of dimples and the second plurality of dimples are arranged so that the longitudinal direction of the first plurality of dimples intersects the longitudinal direction of the second plurality of dimples.

3. The workpiece of claim 1, wherein:
each dimple has a depth measured from the surface,
the depth of each dimple is 10.0 μm or less;
the length of each dimples is measured in the longitudinal direction from a first end of the dimple to a second end of the dimple; and
each dimple slopes downward from the surface of the workpiece an inclination angle of 10° or less at the first end and the second end.

4. A method for forming dimples in a workpiece using a rotary cutting tool, comprising:
rotating a rotary cutting tool about an axis, the rotary cutting tool comprising:
a tool main body rotatably supported and rotatable about the axis; and
a cutting edge provided on a radially outer surface of the tool main; and
feeding the rotary cutting tool along a processing surface of the workpiece so as to form a plurality of dimples in the processing surface with the cutting edge, wherein:
each dimple has a length measured in a longitudinal direction of the dimple and a lateral width measured perpendicular to the longitudinal direction;
each has an aspect ratio equal to the ratio of the length of the dimple to the lateral width of the dimple; and
the aspect ratio of each dimple is greater than or equal to 5.0 and less than or equal to 50.0.

5. The method of claim 4, wherein a ratio of a radius of the tool main body to a radius of curvature of a bottom edge of the cutting edge is greater than or equal to 25.0.

6. The workpiece of claim 2, wherein the longitudinal direction of the first plurality of dimples intersects the longitudinal direction of the second plurality of dimples at an angle ranging from 25° to 90°.

7. The workpiece of claim 2, wherein the longitudinal direction of the first plurality of dimples and the longitudinal direction of the second plurality of dimples converge towards each other in a direction opposite a sliding direction of the surface of the workpiece relative to a counterpart material.

8. The workpiece of claim 1, wherein the longitudinal direction of each of the plurality of dimples is parallel to a sliding direction of the surface of the workpiece.

9. The workpiece of claim 1, wherein a distance between adjacent dimples in the longitudinal direction is greater than the length of each of the adjacent dimples.

10. The workpiece of claim 1, wherein a ratio of the length of each dimple to a depth of each dimple relative to the surface of the workpiece is 8-333, inclusive.

11. A workpiece having a surface, comprising:
a first plurality of dimples in the surface of a workpiece and configured to increase a pressure of an oil film between the workpiece and a counterpart material, wherein:
each of the first plurality of dimples has a length measured in a longitudinal direction of the dimple and a lateral width measured perpendicular to the longitudinal direction;
each of the first plurality of dimples has an aspect ratio equal to the ratio of the length of the dimple to the lateral width of the dimple;
the aspect ratio of each dimple is greater than or equal to 5.0 and less than or equal to 50.0.

12. The workpiece of claim 11, further comprising a second plurality of dimples, wherein:
the first plurality of the dimples are parallel to each other,
the second plurality of dimples are parallel to each other, and
the first and second plurality of dimples are arranged so that the longitudinal direction of the first plurality of dimples intersects a longitudinal direction of the second plurality of dimples.

13. The workpiece of claim 11, wherein:
a depth of each of the first plurality of dimples is 10.0 μm or less, and
the length of each of the first plurality of dimples is measured in the longitudinal direction from a first end of the dimple to a second end of the dimple; and
each of the first plurality of dimples slopes downward from the surface of the workpiece an inclination angle of 10° or less at the first end and the second end.
